(19) United States
(12) Patent Application Publication
(10) Pub. No.: US 2009/0090249 A1
(43) Pub. Date: Apr. 9, 2009

(54) BAKING TRAY WITH SERRATED SURFACE

(76) Inventor: Jui-Jung Chang, Taichung Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/866,651

(22) Filed: Oct. 3, 2007

(51) Int. Cl. A47J 37/01; A47J 27/00; A47J 27/022

(52) U.S. Cl. 99/422; 220/573.1; 99/426

(57) ABSTRACT

A baking tray is a rectangular metal tray and includes a top surface and a bottom. The top surface includes a plurality of protrusions extending therefrom and the protrusions are continuously arranged in latitude and longitude directions. A plurality of recesses is defined between the protrusions so that the bottom of the food on the top surface does not stick on the baking tray and is not burned.

### FIELD OF THE INVENTION

The present invention relates to a back tray with serrated surface so as to provide even baking feature to the food.

### BACKGROUND OF THE INVENTION

A conventional baking tray 120 is shown in FIG. 8 and generally includes a top surface 121 on which the food 10 is put. The top surface is a flat surface and the bottom of the food 10 directly contacts the top surface 121 so that there is no gap defined between the bottom of the food 10 and the top surface 121. The bottom of the food 10 such as the dough completely sticks on the flat top surface 121 and easily burns due to over heat. Besides, because the flat top surface 121, the bottom of the food 10 may be peeled off from the food when removing the food 10 from the top surface 121.

The present invention intends to provide a baking tray which includes serrated surface which is composed of continuous protrusions which allow the bottom of the food not to be stuck on the serrated surface and the bottom of the food does not burn.

### SUMMARY OF THE INVENTION

The present invention relates to a baking tray which comprises a top surface and a bottom. The top surface includes a plurality of protrusions extending therefrom and the protrusions are continuously arranged in latitude and longitude directions.

The primary object of the present invention is to provide a baking tray having serrated top surface so as to provide gaps between the bottom of the food and the top surface of the baking tray. By this specific structure, the food does not burn and stick on the tray.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the baking tray of the present invention;

FIG. 2 is an enlarged view to show a part of the baking tray of the present invention;

FIG. 3 is a top view to show the baking tray of the present invention;

FIG. 4 shows each protrusion is composed of four rectangular inclined surfaces;

FIG. 5 shows a part of another embodiment of the baking tray of the present invention;

FIG. 6 is a side view to show a side view of the baking tray of the present invention;

FIG. 7 is a side view to show food is put on the top surface of the baking tray of the present invention, and

FIG. 8 is a side view to show food is put on the top surface of a conventional baking tray.

### DETAILED DESCRIPTION OF THE PREFERRED EMBODIMENT

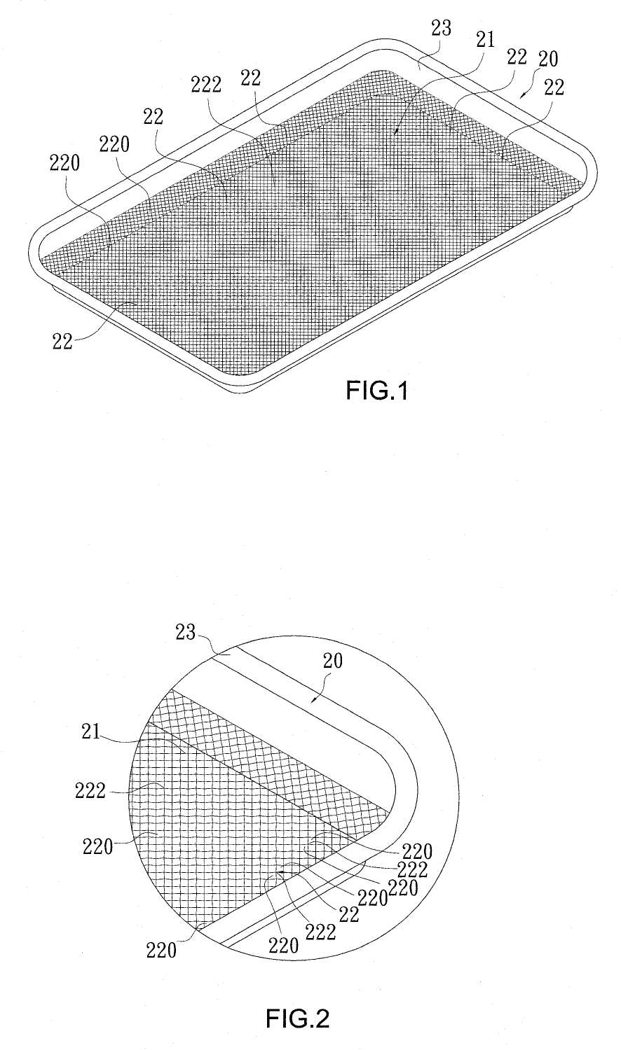

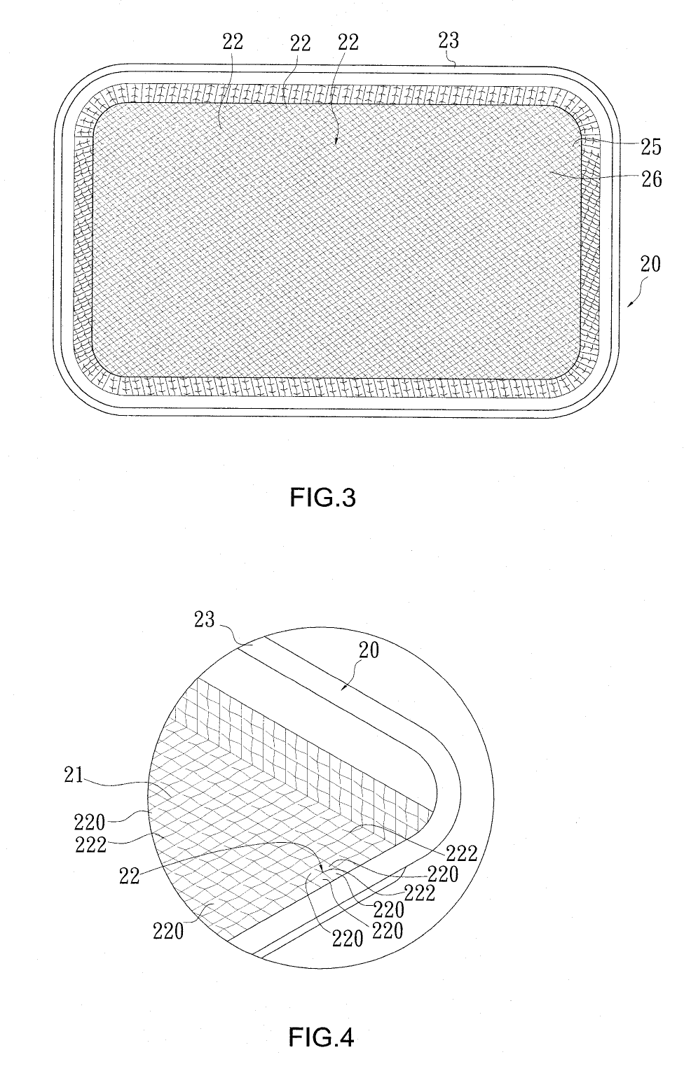

Referring to FIGS. 1 to 4 and FIG. 7, the baking tray 20 for food 10 of the present invention is made by way of pressing or rolling from a metal board. In this embodiment, the baking tray 20 is a rectangular tray and includes a top surface 21, a bottom 25 and a sidewall 23 extends from a peripheral of the top surface 21 of the baking tray 20. A plurality of protrusions 22 extend from the top surface 21 and the protrusions 22 are continuously arranged in latitude and longitude directions. A plurality of protrusions 22 extend from an inside of the sidewall 23.

Referring to FIG. 6, a recess 24 is defined between any two adjacent protrusions 22 and notches 240 are defined in the bottom 25 of the baking tray 20 and located corresponding to the protrusions 22 on the top surface 21.

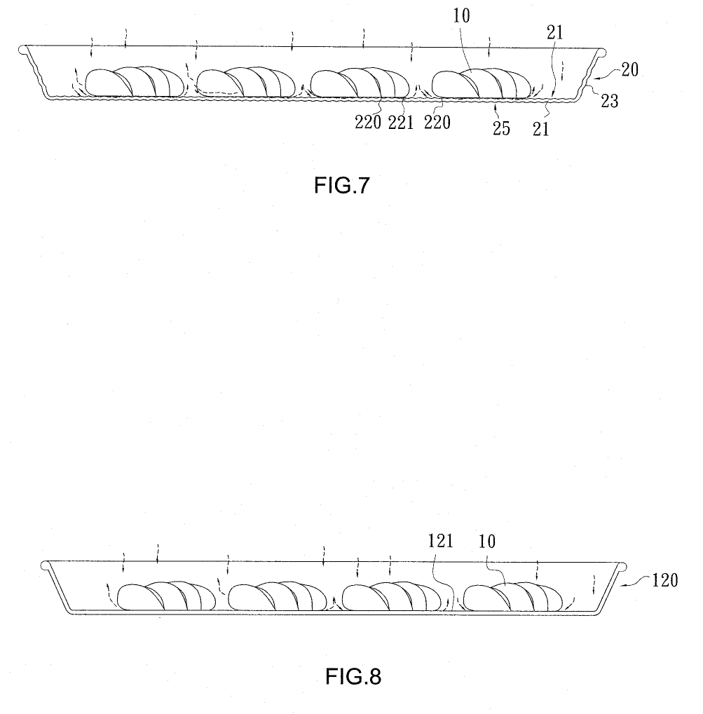

As shown in FIG. 7, food 10 such as dough is put on the top surface 21 of the baking tray 20 and gaps are defined between the bottom of the food 10 and the top surface 21 of the baking tray 20. The serrated top surface 21 prevents the bottom of the food 10 from being burned and stuck on the top surface 21 of the baking tray 20.

As shown in FIG. 4, each protrusion 22 is composed of four rectangular inclined surfaces 220 which are jointed on a common top portion 222.

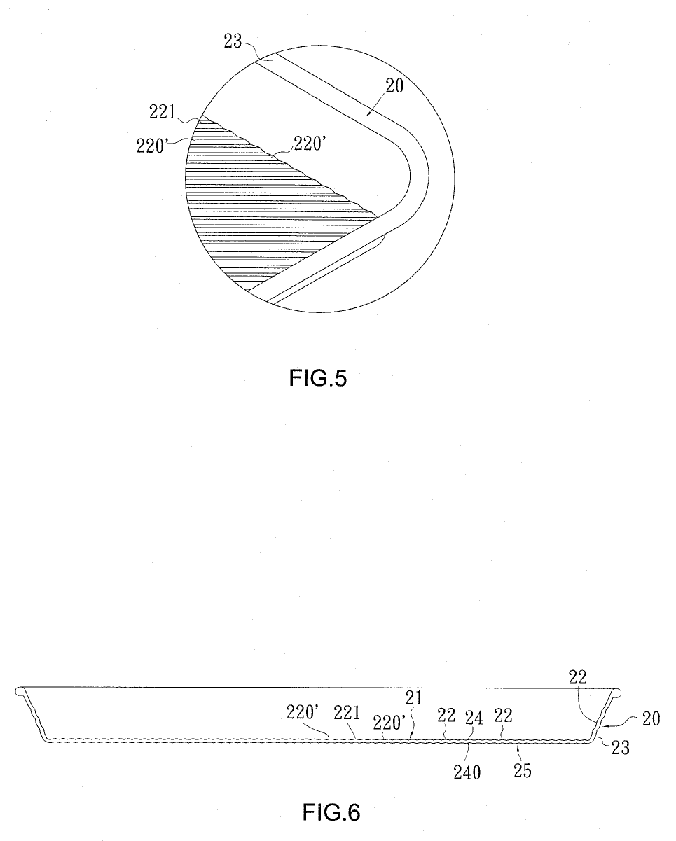

As shown in FIGS. 5 and 6, each protrusion 22 can also be composed of two elongate inclined surfaces 220′ which are jointed on a common top portion 221.

While we have shown and described the embodiment in accordance with the present invention, it should be clear to those skilled in the art that further embodiments may be made without departing from the scope of the present invention.

What is claimed is:

1. A baking tray comprising:
a top surface and a bottom, the top surface including a plurality of protrusions extending therefrom and the protrusions are continuously arranged in latitude and longitude directions.

2. The baking tray as claimed in claim 1, wherein the baking tray is made by way of pressing or rolling from a metal board, a sidewall extends from a peripheral of the baking tray and a plurality of protrusions extend from an inside of the sidewall.

3. The baking tray as claimed in claim 1, wherein the baking tray is a rectangular tray.

4. The baking tray as claimed in claim 1, wherein a recess is defined between any two adjacent protrusions.

5. The baking tray as claimed in claim 1, each protrusion is composed of two elongate inclined surfaces which are jointed on a common top portion.

6. The baking tray as claimed in claim 1, each protrusion is composed of four rectangular inclined surfaces which are jointed on a common top portion.

7. The baking tray as claimed in claim 1, wherein notches are defined in the bottom of the baking tray and located corresponding to the protrusions on the top surface.
